(19) United States
(12) Patent Application Publication
(10) Pub. No.: US 2003/0064702 A1
(43) Pub. Date: Apr. 3, 2003

(54) Network communication casing

(76) Inventors: Robert L. Van Egmond, Hillsboro, OR (US); Shawn S. Mceuen, Hillsboro, OR (US); Gary L. Bookhardt, Beaverton, OR (US); Doug G. Bennett, Beaverton, OR (US); Justin M. Huttula, Portland, OR (US); Josh Gordon, Portland, OR (US); Ryan Wilday, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/964,502

(22) Filed: Sep. 28, 2001

(51) Int. Cl. H04B 1/08

(52) U.S. Cl. 455/347

(57) ABSTRACT

A housing device is described that protects hardware and software useful in connecting a personal computer (PC) to a network. The housing device is versatile so as to allow for a plurality of configuration and installation combinations. This versatility allows an installer to mount the housing device either horizontally or vertically. When mounted horizontally, the installer has yet another option to prop the housing device upright via use of an easel on the back or allow it to lie flat with the easel folded under a main body component. Serrated edges are provided on the easel so as to allow for tension to be placed on the wires or cables coupled to the housing device so that the wires or cables do not become disconnected from the housing device.

### RELATED APPLICATIONS

This application is related to U.S. Design Application No. ______ , filed concurrently with this application and titled “NETWORK COMMUNICATION HOUSING.”

### TECHNICAL FIELD

This invention relates to a network communication housing device, and more particularly to a network communication housing device that is versatile in installation and use, aesthetically pleasing and efficient in holding wires and cables in place.

### BACKGROUND

A network couples computers together so that the computers may share information and data. This makes networked computers much more valuable to the end user because it permits the end user to do more with the computer by sharing data and applications with other users through the network.

In general, there are three classes of networks. The first class includes Local Area Networks (LANs). Typically, LANs are small networks with short distances between computers and are proprietary (i.e., limited access) to a single company. LANs are typically used in office buildings and small campuses.

The second class includes Metropolitan Area Networks (MANS) that are larger networks. A typical MAN network is one that links together two or more LANs.

The third class includes Wide Area Networks (WANs). These networks are geographically larger than the other two classes. In addition, WANs typically couple together LANs over common carrier lines or lines leased from a common carrier.

To get coupled to a network, a personal computer (PC) needs hardware and/or software to interface with the network to transmit and receive signals. One example of hardware is an Ethernet card used in LANs. A modem is an example of networking hardware that often is used to couple a PC to a server in a WAN.

Network devices can be categorized into two types. The first type is mounted onto a motherboard and hidden from plain view. The second type sits in plain view and has wires running from it to both the PC and the networks to which the PC is coupled.

### DESCRIPTION OF DRAWINGS

FIG. 1 is a front view of a network communication housing positioned on a surface.

FIGS. 2 and 3 are side and top views of the network communication housing of FIG. 1.

FIG. 4 is a back view of the network communication housing of FIG. 1.

FIG. 5 is a front view of a main body of the network communication housing of FIG. 1.

FIG. 6 is an isometric view of the network communication housing of FIG. 1.

FIG. 7 is an isometric view of a hinge of the network communication housing of FIG. 1.

FIG. 8 is a top view of an easel of the network communication housing of FIG. 1.

FIG. 9 is a cross-sectional side view of the network communication housing of FIG. 1 with a cable in a first arrangement.

FIG. 10 is a cross-sectional side view of the network communication housing of FIG. 1 with a cable in a second arrangement.

FIG. 11 is a view of a serrated edge on an easel of the network communication housing of FIG. 1.

Like reference symbols in the various drawings indicate like elements.

### DETAILED DESCRIPTION

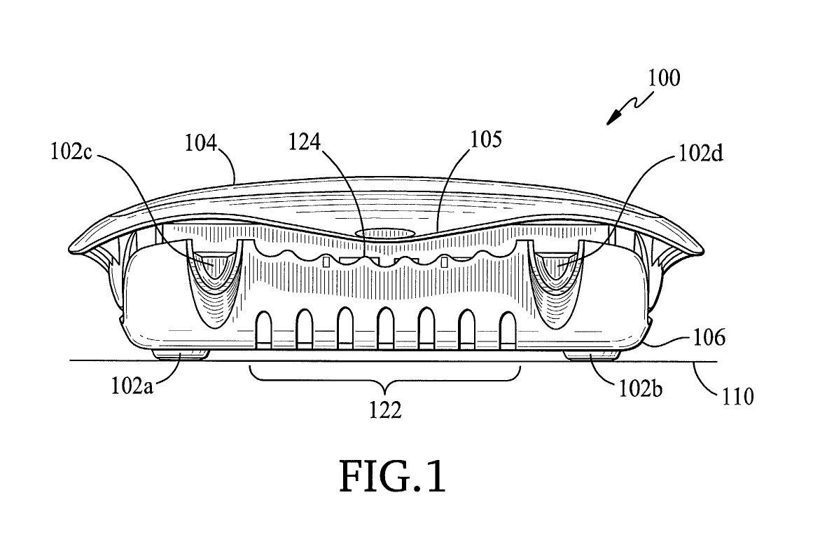

Referring to FIGS. 1-6, a network communication housing 100 includes a main body 104 and an easel 106. In one implementation, main body 104 is a hollow shell made of plastic. Inside main body 104 is network circuitry (not shown) that connects a personal computer (PC) to one or more networks or devices. In one implementation, the network circuitry is a low cost digital subscriber line service (DSL) to 10/100 Ethernet bridge/router. Other implementations may provide other types of modems or other functions useful in connecting a computer to one or more networks or devices. In addition, other implementations of main body 104 may be made of wood or metal. It should also be noted that some implementations of main body 104 include electromagnetic interference (EMI) shielding (not shown). This EMI shielding is typically a conductive material placed on the interior surface of main body 104. The EMI shielding reflects radiation away from network circuitry and thereby improves performance of the network circuitry.

Easel 106 may define several holes 122 and may include feet 102a-102f. In one implementation, easel 106 is made of plastic. Easel 106 aids in the support of main body 104 and in cable management as described below. Feet 102a-102f support network communication housing 100 on a surface 110 that may be a horizontal surface or a vertical surface depending on how the network communication housing 100 is installed and whether the housing 100 is in an open or closed configuration. In one implementation, feet 102a-102f are made from the same or similar plastic as main body 104 and easel 106. Easel 106 may also define a serrated edge 124 that helps to hold wires and cables in place. Wires and cables are transmission media in a defined space that allow signals to be communicated between two or more devices. Examples of wires and cables include twisted pairs of wires, coaxial cables and fiber optic cables. It should be noted that wires and cables that are coupled to the housing to complete the network connection are not shown in FIG. 1 for the sake of clarity. Similarly, a wire or cable that supplies power to the network circuitry inside main body 104 also is not shown for the sake of clarity. Serrated edge 124 may be used to control the wires and cables as they exit the network communication housing 100. Easel 106 may also define holes 122. Some of these holes 122 may be used to control the wires and cables as they exit network communication housing 100, while other holes 122 may be used to vent any heat generated by the network circuitry.

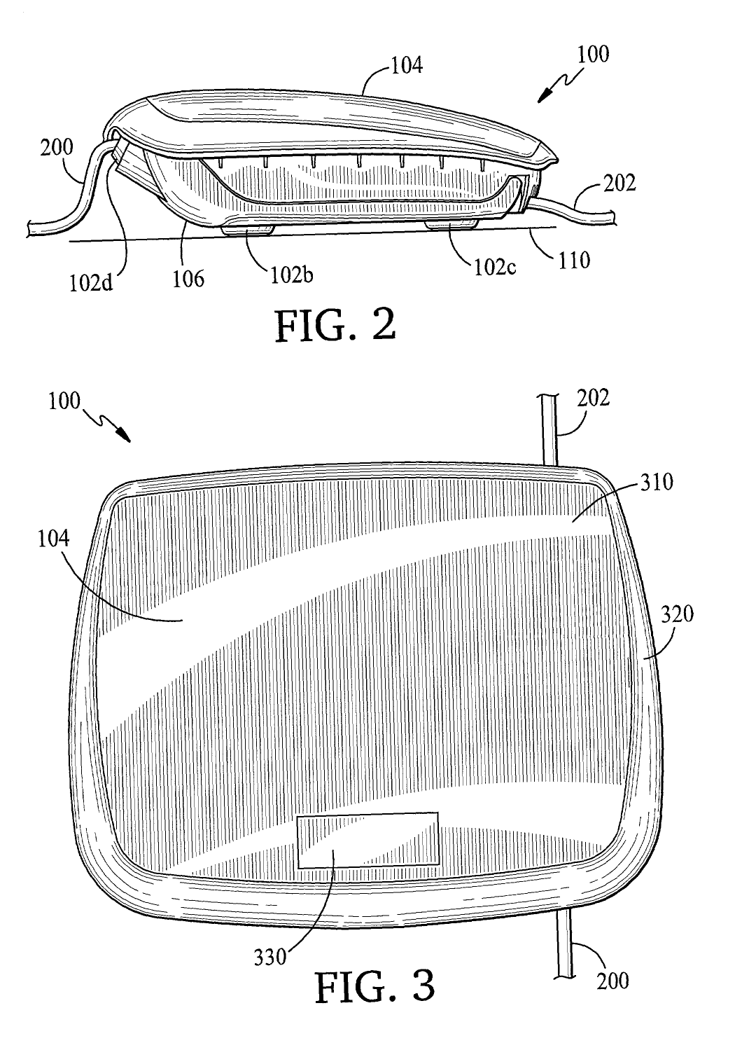

Referring to FIG. 2, cables 200 and 202 may be coupled to housing 100. Cable 200 extends from the front of housing 100 and cable 202 extends first from the front of the network communication housing 100 but is bent under so as to exit from the back of the housing 100.

Referring to FIG. 3, only the main body 104 is visible because main body 104 has a larger surface area than easel 106. However, it should be noted that alternative implementations may provide easel 106 with a larger surface area than main body 104.

In the implementation shown in FIG. 3, main body 104 has a top surface 310 and a beveled surface 320. Top surface 310 may include an area 330 for a trademark or logo to identify the source of network communication housing 100. Cable 200 is also shown extending from the front of housing 100 and cable 202 is shown extending from the back of housing 100.

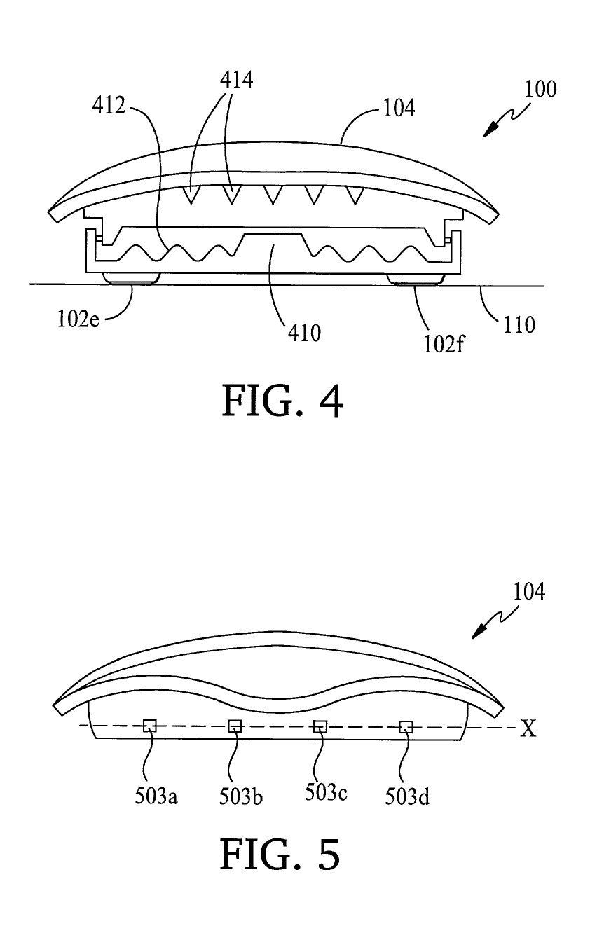

Referring to FIG. 4, easel 106 may define a stop 410 and a serrated edge 412 that holds wires and cables. Main body 104 includes vents 414 that dissipate heat generated by the internal network circuitry (not shown). In an alternative implementation, serrated edge 412 may be placed on main body 104 instead of easel 106.

FIG. 5 shows main body 104 without easel 106. This view exposes connectors or jacks 503a-503d, which couple the wires and cables with the network circuitry housed within main body 104. Connectors 503a-503d may provide a point of mechanical attachment to far wires and cables to attach to main body 104 as well as an electrical or optical coupling between the network circuitry and the wires or cables.

Connectors 503a-503d may be either male or female and may be compatible with corresponding female or male coaxial jacks or registered jacks (e.g., RJ-11, RJ-22, RJ-45).

In the illustrated implementation, main body 104 has four connectors. It should be understood that different numbers and types may be used. Similarly, a collection of different sized connectors to accommodate different sized wires or cables or different types of coupling devices (e.g., metal clips or screws) also may be used in alternative implementations. Finally, while FIG. 5 shows the connectors arranged together in a lateral plane x, alternative designs of main body 104 may have the connectors arranged in two or more lateral planes.

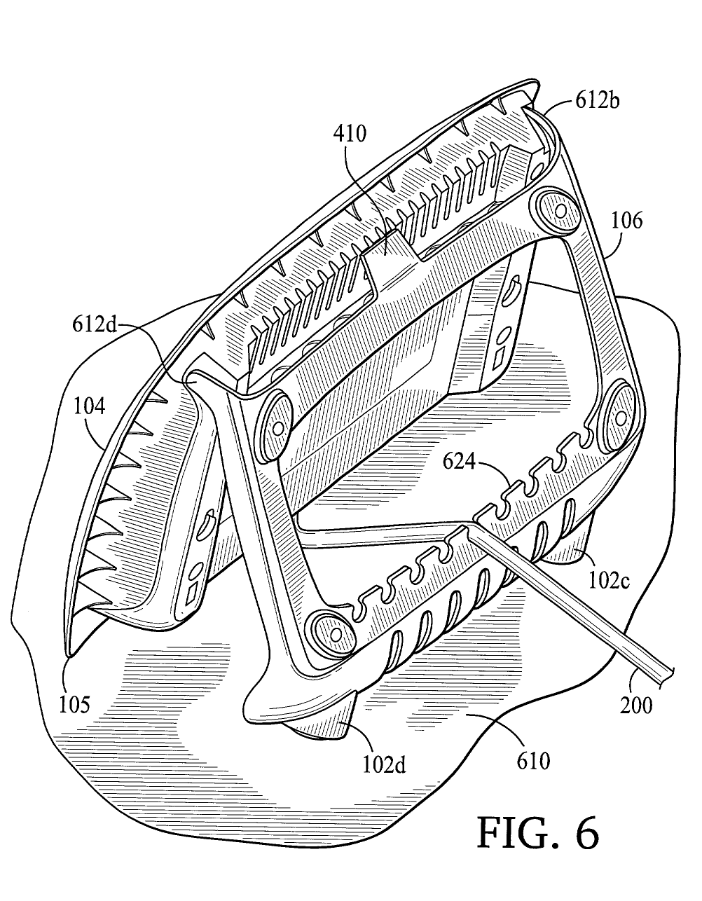

As shown in FIG. 6, network communication housing 100 may rest on a horizontal surface 610 with main body 104 resting on a foot or edge 105 and easel 106 resting on feet 102c and 102d. Cable 200 is coupled to one of the connectors 503a-503d (not shown) on the front of network communication housing 100 and is fed through easel 106 and over serrated edge 624. In one implementation, fee 102c and 102d are angled with respect to easel 106. In this manner, when the network communication housing 100 is in the open configuration on a horizontal surface 610, feet 102c and 102d will lie flat on horizontal surface 610 so as to provide maximum stability.

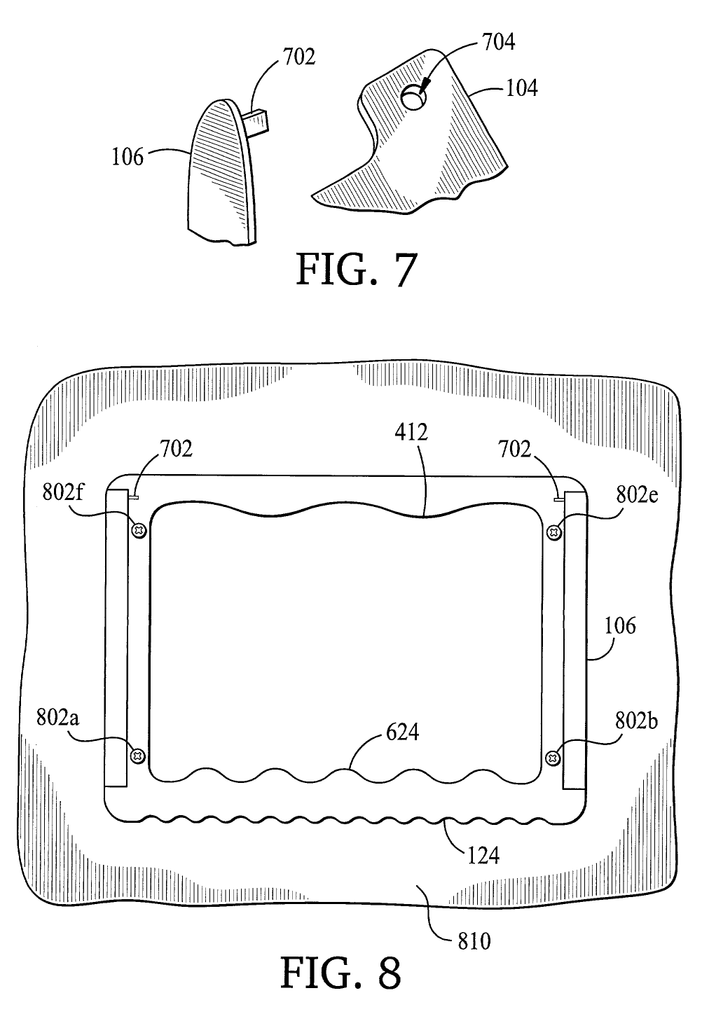

To achieve the open configuration, hinges 612a and 612b may be used to connect main body 104 to easel 106. Referring to FIG. 7, hinge 612a may include a round pin 702 and a hole 704. In one implementation, easel 106 has round pin 702 and main body 104 has hole 704 while other implementations have round pin 702 located on main body 104 and hole 704 located on easel 106. Hole 704 is sized to accept pin 702 and allow for rotation of pin 702. It should be noted that other types of hinges, such as a hinge including two plates and a rod that threads through eyes on the plates, also may be used.

Housing 100 provides protection to the internal network circuitry and software that performs the interfacing process between the PC and the network(s). As a protective casing, network communication housing 100 keeps dust, debris, unwanted objects and liquids from contacting the internal network circuitry and causing either a decrease in performance or a total failure. If main body 104 includes EMI shielding, network communication housing 100 will also protect the network circuitry from radiation as previously described.

Network communication housing 100 also provides for different installation methods such that it can be used in different environments. More specifically, network communication housing 100 can be installed on both vertical and horizontal surfaces depending on the environment and personal choice. Also, when installed horizontally, the user has the option of having housing 100 in a closed configuration or an open configuration.

The network communication housing 100 may be mounted in a vertical, closed configuration, a horizontal, closed configuration, and a horizontal, open configuration. FIG. 8 shows easel 106 separated from main body 104 for the purpose of illustrating vertical mounting of housing 100 in a closed configuration. To mount easel 106 onto a vertical surface 810, fasteners 802a, 802b, 802e and 802f are driven through holes in easel 106 and into vertical surface 810. As shown in FIG. 8, the holes in easel 106 are centered in each of the feet 102a, 102b, 102e and 102f and the fasteners 802a, 802b, 802e and 802f are screws. It should be noted that other fasteners such as nails, glue or other adhesives also may be used to mount easel 106 onto vertical surface 810. It should also be noted that the holes in easel 106 may be placed at other points along the easel rather than through the centers of the feet 102a, 102b, 102e and 102f.

Once easel 106 is mounted onto vertical surface 810, the necessary wires or cables are connected to main body 104, and main body 104 is clipped into place over easel 106. This is accomplished in an implementation where easel 106 is made out of plastic, such that it has enough flexibility in it to allow it to be slightly bent in order to fit pin 702 into hole 704 of hinges 612a and 612b.

Once main body 104 is clipped into place, main body 104 pivots about hinges 612a and 612b to the closed position. Cables 200 and 202 are kept in place by serrated edges 124 and 412 and are fed out the front or back of housing 100 depending on the needs and desires of the installer. Alternatively, cable 200 is fed out of the front of housing 100 via one of the holes 122.

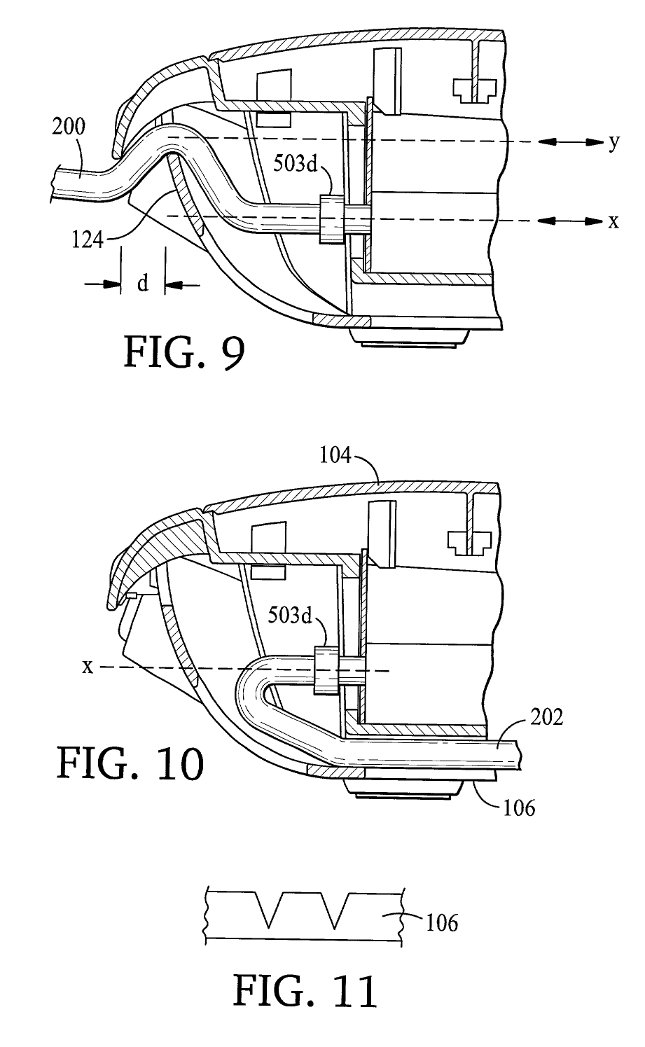

Another feature of the housing 100 is the ability to apply tension to the wires and cables to keep them from coming loose from connectors 503a-503d. FIG. 9 shows housing body 100 with cable 200 coupled to connectors 503d and fed out of the front of housing body 100. As shown, serrated edge 124 is on a plane y that is different from the plane x plane occupied by the jacks 503a-503d. In addition, main body 104 has an overlap d over easel 106. Having serrated edge 124 above connectors 503a-503d causes cable 200 to bend upward, and having main body 104 overlap easel 106 causes wire 200 to bend downward and away from serrated edge 124. This causes a general “C” shape in cable 200. By bending cable 200 in this manner, tension is applied to cable 200 against connector 503d to prevent cable 200 from separating from connector 503d.

Referring to FIG. 10, cable 202 runs out of the back of housing device 100. Like the configuration shown in FIG. 9, cable 202 is coupled to connector 503d. Unlike FIG. 9, cable 202 is bent downward and runs underneath main body 104. This “C-shaped” bend in cable 202 creates tension which helps maintain cable 202 onto connector 503d. Easel 106 captures cable 202 and keeps it underneath main body 104. Cable 202 exits housing device 100 over serrated edge 412. Serrated edge 412 is similar to serrated edge 124 except that it is not necessarily on a different plane than the substantially lateral plane x occupied by jacks 503a-503d.

Serrated edges 124 and 412 limit lateral movement. In FIGS. 9 and 10, this movement would be of the cables into and out of the page. Serrated edges 124 and 412 also aid in the maintenance of the tension on the cables connected to housing 100. More specifically, each individual notch in serrated edges 124 and 412 may be sized to accept a wire or cable with a specific circumference. In this manner, when the wire or cable is placed into a notch in either serrated edge, a slight amount of force is required to engage the wire or cable into the notch. Thus, the cables are prevented from moving laterally by the sides of each notch and the friction fit with each notch in serrated edges 124 and 412. These restraints in movement prevent the wires/cables from working loose and disconnecting from connectors 503a-503d.

In other implementations, the individual notches in serrated edges 124 and 412 may be of varying sizes to accommodate wires and cables of varying circumferences. Each notch of a specific size is aligned with a correspondingly sized connector in a plane perpendicular to the substantially lateral plane x. In other implementations, each individual notch may be larger to accommodate a bundle of wires or cables instead of a single wire or cable. Such exemplary notches are shown in serrated edges 124, 412 and 624 in FIG. 6. In these alternative serrated edges, the wires or cables are not necessarily force-fitted into the notches as described previously.

In yet another implementation, the notches in serrated edges are 124 and 412 may be “V” shaped as shown in FIG. 11, which may provide an advantage over the semi-circular notches in that they are more versatile in the sizes of cables that they can accept. Smaller cables are simply pushed further into the “V” notch than larger cables. This allows for any cable, regardless of its circumference, to be friction fit into any “V” notch in serrated edges 124 and 412.

As discussed previously, FIGS. 1-4 show network communication housing 100 in the closed configuration, in which surface 110 is horizontal. In this configuration, easel 106 typically is not secured to horizontal surface 110. However, easel 106 may be secured to the horizontal surface 110 using screws, nails, glue, adhesives or any other known conventional method in a manner similar to that described previously. Cables 200 and 202 then are coupled to connectors 503a-503d and the cables are fed out of the front or back of the housing body as shown in FIGS. 9 and 10.

FIG. 6 shows the housing 100 in the horizontal, open configuration. As shown, easel 106 and main body 104 are pivoted with respect to each other to obtain the open configuration. As described previously, cables are coupled to connectors 503a-503d as the cables are fed over serrated edge 624 on easel 106.

When configured in the upright position as shown in FIG. 6, main body 104 rests on foot or edge 105 on horizontal surface 610 while easel 106 rests on feet 102c and 102d. Main body 104 and easel 106 pivot around hinges 612a and 612b as previously described. Stop 410 prevents main body 104 and easel 106 from pivoting too much. This is accomplished by having stop 410 come into contact with main body 104 when the main body 104 and easel 106 are pivoted open.

In this configuration, tension is still applied to the wires and cables as in the closed configurations. The cables are coupled to connectors 503a-503d on the front of main body 104. The cables are then fed through easel 106 and placed into notches in serrated edge 624. Due to the orientation of jacks 503a-503d, cable 200 is bent into a “C” shape. This occurs because the portion of cable 200 nearest to connectors 503a-503d is oriented perpendicularly to horizontal surface 610. Wire 200 then is bent back over serrated edge 624 on easel 106. This down and back bend creates the “C” shape which applies tension to cable 200 and aids in maintaining the connection between cable 200 and the jack to which it is coupled.

Also as described above in the other configurations, notches in serrated edge 624 may be sized so as to accept the cables with a slight amount of force. This prevents the cables from moving laterally as previously described. It should be noted that notches of various sizes and alternative shapes, such as a “V” notch, are used in other variations of serrated edge 624. A description of other types of notches was provided with respect to the description of serrated edges 124 and 412 above.

Network communication housing 100 is useful in a number of networking environments. In an exemplary implementation, the internal circuitry in main body 104 is an interface between a digital subscriber line (DSL) and a 10/100 Ethernet LAN. In this implementation, the internal network circuitry provides both routing in the LAN environment and a bridge between the DSL environment and the LAN environment. It should be noted that alternative internal network circuitry also may be incorporated into housing device 100.

A number of implementations have been described. Nevertheless, it will be understood that various modifications may be made. For example, feet 102a, 102b, 102e and 102f can be replaced with a single foot that is affixed around the circumference of easel 106. Alternatively, all or some of the feet 102a-102f may be made of soft, rubber-like pads.

In addition, hinges joining main body 104 to easel 106 may be relocated. FIG. 6 shows hinges 612a and 612b on the opposite side of main body 104 from connectors 503a-503d. In alternative implementations, the hinges are placed on sides of main body 104 adjacent to the side containing connectors 503a-503d.

There are also alternative notch shapes other than the semi-circle and “V” shapes described above. For example, rectangular, semi-hexagonal, semi-octagonal or other shapes may be implemented into easel 106.

In addition to the notches in the serrated edges being of different geometries, main body 104 and easel 106 also may be of geometries that differ from the substantially rectangular shapes shown in FIGS. 1-10. Geometric shapes such as circles, triangles, hexagons, octagons or any other polygon are contemplated. Similarly, main body 104 and easel 106 do not necessarily need to be of similar shape. As an example, main body 104 could be substantially rectangular while easel 106 is substantially hexagonal.

Easel 106 also may be modified. For example, a clamping bar with a complimentary serrated edge can be added to easel 106 and slid up the easel to release the wires/cables and down the easel to clamp the cables between the clamping bar and serrated edge 624.

In yet another modification, stop 410 may be replaced with two stops that are placed closer to hinges 612a and 612b. Alternatively, stop 410, or other stops near the hinges, may be attached to main body 104 instead of easel 106 and may prevent housing body from opening too much by having these alternative stops engage easel 106 when housing device 100 is in the open configuration.

In yet another alternative implementation, one or more latches or locking mechanisms may be added to the front of main body 104 so that the main body 104 and easel 106 are latched together when housing 100 is in the closed configuration. Examples of latches include tabs on both easel 106 and main body 104. These tabs each have an edge perpendicular to the tabs with the edge on one tab being engaged by the perpendicular edge on the other tab. To release this latch merely requires pushing the tabs apart so that their respective perpendicular edges are disengaged.

One example of a locking mechanism includes screws to tighten the easel 106 and main body 104 together in the closed configuration. These latches and locking mechanisms assist in maintaining the tension on the cables and provide for a cleaner look of the device when installed in the closed configuration.

Easel 106 also may be modified to contain serrated edges other than those previously described. More specifically, edges 124, 412 and 624 are generally parallel to connectors 503a-503d. Additional serrated edges can be added to the sides of easel 106 that are perpendicular to connectors 503a-503d.

In yet another modification, main body 104 may be equipped with holes or tabs for mounting main body 104 directly onto a vertical or horizontal surface instead of easel 106. Once main body is mounted onto the surface, easel 106 is attached and closed over main body 104. The closing of easel 106 creates the bends in the wires and cables as previously described, and this, in turn, puts tension on the wires and cables to prevent them from coming loose from housing device 100.

Accordingly, other implementations are within the scope of the following claims.

What is claimed is:

1. A network communication housing comprising:
a main body;
at least one connector mounted onto a surface of the main body; and
an easel pivotally coupled to the main body.

2. The network communication housing of claim 1 further comprising:
at least one networking circuit located inside the main body that is coupled with the at least one connector; and
electromagnetic interference shielding mounted onto the main body.

3. The network communication housing of claim 1 in which the easel further comprises at least one serrated edge for accepting a wire or cable.

4. The network communication housing of claim 3 in which the at least one serrated edge is comprised of at least one semi-circular notch.

5. The network communication housing of claim 3 in which the at least one serrated edge is comprised of at least one “V-shaped” notch.

6. The network communication housing of claim 1 in which the easel contains at least one hole for accepting at least one wire or cable.

7. The network communication housing of claim 1 in which the easel further comprises:
a stop to prevent the easel from pivoting too far.

8. The network communication housing of claim 1 in which the main body has an edge that overlaps an edge of the easel.

9. The network communication housing of claim 1 in which the easel includes a first serrated edge located at a front side of the housing device and the main body includes a second serrated edge located at a backside of the housing device in which both the first and second serrated edges can accept at least one wire or cable.

10. A method of coupling a wire or cable to a network device comprising a main body, networking circuitry, at least one connector mounted on the main body and coupled to the networking circuitry, and an easel, the method comprising:
coupling the wire or cable to the at least one connector;
securing the wire or cable into a notch on a serrated edge on the easel; and
pivoting the main body and easel to provide tension on the wire or cable.

11. The method of claim 10 in which the pivoting comprises closing the main body and easel with respect to each other.

12. The method of claim 11 in which the tension on the wire or cable is obtained by the easel bending the wire or cable into a “C-shape” before the wire runs from the rear of the housing device.

13. The method of claim 11 in which the tension on the wire or cable is obtained by a n overlap of the main body that causes the wire or cable to bend in a “C-shape” over the serrated edge.

14. The method of claim 10 in which the pivoting comprises opening the main body and easel with respect to each other.

15. The method of claim 10 further comprising mounting the easel onto a surface.

16. The method of claim 10 in which the securing the wire or cable further comprises using force to insert the wire or cable into a notch on the serrated edge.

17. A network communication housing comprising:
an easel with a first edge and at least one foot for supporting the main body;
a main body pivotally coupled with the easel, the main body comprised of a second edge that overlaps the first edge of the easel, at least one connector mounted onto a surface of the main body.

18. The network communication housing of claim 17 in which the at least one foot traverses a circumference of the easel.

19. The network communication housing of claim 17 in which the at least one foot is comprised of four feet.

20. The network communication housing of claim 17 in which the easel is comprised of a serrated edge.

21. The network communication housing of claim 17 wherein a wire or cable is coupled with at least one connector and the wire or cable passes over the first edge.

22. The network communication housing of claim 21 wherein the wire or cable passes under the second edge.

23. The network communication housing of claim 17 wherein a wire or cable is coupled with at least one connector and the wire or cable passes through a hole in the easel.

24. The network communication housing of claim 17 wherein a wire or cable is operatively coupled with at least one connector and with at least one computer.

25. The network communication housing of claim 17 wherein:
a wire or cable is operatively coupled with at least one connector and with at least one network.

26. The network communication housing of claim 17 wherein at least one foot is located on the easel at an angle that allows the easel and main body to stand flat on a horizontal surface in an open configuration.
